(19) United States
(12) Patent Application Publication
(10) Pub. No.: US 2015/0206255 A1
(43) Pub. Date: Jul. 23, 2015

(54) METHOD AND SYSTEM TO PRESCRIBE VARIABLE SEEDING DENSITY ACROSS A CULTIVATED FIELD USING REMOTELY SENSED DATA

(71) Applicant: HydroBio, Inc, Santa Fe, NM (US)

(72) Inventor: David P. Groeneveld, Santa Fe, NM (US)

(73) Assignee: HydroBio, Inc, Santa Fe, NM (US)

(21) Appl. No.: 14/676,660

(22) Filed: Apr. 1, 2015

Related U.S. Application Data
(63) Continuation-in-part of application No. 13/455,987, filed on Apr. 25, 2012.
Application No. 13/455,987 is a continuation-in-part of application No. 13/455,971, filed on Apr. 25, 2012.
(60) Provisional application No. 61/490,499, filed on May 26, 2011.
(60) Provisional application No. 61/486,193, filed on May 13, 2011.
(60) Provisional application No. 61/490,499, filed on May 26, 2011.
(60) Provisional application No. 61/486,193, filed on May 13, 2011.
(60) Provisional application No. 61/973,757, filed on Apr. 1, 2014.

(51) Int. Cl. G06Q 50/02; A01C 7/00; G06Q 10/06; A01C 21/00

(52) U.S. Cl. CPC G06Q 50/02; A01C 21/005; A01C 7/00; G06Q 10/06313

(57) ABSTRACT

A method for prescribing variable seed density planting. The method can include: obtaining first EOS data collected approximately on an estimated day (DOY′) during a past crop-growing season in which NDVI* data most closely resembles a spatial-yield pattern measured during harvest in the past crop-growing season; converting the first EOS data to first reflectance data and first NDVI data; calculating first NDVI* data on a per pixel basis for the first EOS data based on the first NDVI data using satellite scene statistics of the first EOS data; generating an NDVI* map for a first field using the first NDVI* data for the first EOS data; and generating a variable seed density prescription map using the NDVI* map. The variable seed density prescription map can be spatially defined. Other embodiments are provided.

### CROSS-REFERENCE TO RELATED APPLICATIONS

This application is a continuation-in-part of U.S. patent application Ser. No. 13/455,987, filed Apr. 25, 2012, which claims the benefit of U.S. Provisional Application No. 61/490,499, filed May 26, 2011, and U.S. Provisional Application No. 61/486,193, filed May 13, 2011. This application also is a continuation-in-part of U.S. patent application Ser. No. 13/455,971, filed Apr. 25, 2012, which claims the benefit of U.S. Provisional Application No. 61/490,499, filed May 26, 2011, and U.S. Provisional Application No. 61/486,193, filed May 13, 2011. This application also claims the benefit of U.S. Provisional Application No. 61/973,757, filed Apr. 1, 2014. U.S. patent application Ser. Nos. 13/455,987 and 13/455,971, and U.S. Provisional Application Nos. 61/973,757, 61/490,499, and 61/486,193 are incorporated herein by reference in their entirety.

### TECHNICAL FIELD

This disclosure relates generally to precision agriculture and more specifically to varying seeding density across a cultivated field targeted discretely based upon remote sensing-measured spatial patterning in the crop canopy.

### BACKGROUND

Precision agriculture technology is intended to achieve the highest possible yields from a cultivated field using a minimum of inputs, thereby controlling costs, conserving resources, and obtaining the highest possible profit. This technology generally includes varying the population density of seeds for the crop according to the soil capability, which include the physical and chemical conditions that contribute to or impede crop yield. The value provided by varying the population density of plants in a crop arises because portions of a field with high soil capability that can sustain high yields should receive greater density of seeds per unit area to support the desired higher yield. In locations within the field with poor soil capability, lower population densities are generally planted. Lower seed density can actually enhance yield in locations with poor soil capability through reduction of competition among individual plants for limiting water and nutrients. Variable density seeding and its benefits is an emerging science within precision agriculture. Crop-specific seeding densities are provided by most seed companies based on what the field sub-region can yield, but maps of spatially-variable yields for spatially-variable seed population densities are often not available or are fraught with errors.

### BRIEF DESCRIPTION OF THE DRAWINGS

To facilitate further description of the embodiments, the following drawings are provided in which:

FIG. 1 illustrates a chart showing representative median values for NDVI* from serial images that were extracted for an example corn field plotted by the corresponding day of year (DOY);

FIG. 2 illustrates an exemplary time series of NDVI* images to calibrate the elapsed days from AED for the best signature of yield from EOS data (September 3) for the yield measured during harvest of a corn field;

FIG. 3 illustrates a graph of elapsed days from AED for NDVI* to forecast a date for remotely sensed display of the spatial-yield pattern for corn, according to an embodiment;

FIG. 4 illustrates eight quantile classes of NDVI* for an exemplary corn field, as shown in FIG. 4(a), that are reclassified into three percentile classes, as shown in FIG. 4(b), according to an embodiment;

FIG. 5 illustrates a flow chart for a method of calibrating the clocking function for a crop, which can be used determine when to acquire an EOS snapshot of the field to represent the spatial pattern of soil capability, according to an embodiment;

FIG. 6 illustrates a flow chart for a method 600 of operational remote sensing for planting a field, according to an embodiment;

FIG. 7 illustrates a computer that is suitable for implementing the device of FIG. 9;

FIG. 8 illustrates a representative block diagram of an example of elements included in circuit boards inside a chassis of the computer of FIG. 7; and

FIG. 9 illustrates a block diagram of a device that is suitable for implementing the methods described herein.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

Various embodiments can include a method for prescribing variable seed density planting. The method can include obtaining first EOS data collected approximately on an estimated day (DOY′) during a past crop-growing season in which NDVI* data most closely resembles a spatial-yield pattern measured during harvest in the past crop-growing season. The method also can include converting the first EOS data to first reflectance data and first NDVI data. The method additionally can include calculating first NDVI* data on a per pixel basis for the first EOS data based on the first NDVI data using satellite scene statistics of the first EOS data. The method further can include generating an NDVI* map for a first field using the first NDVI* data for the first EOS data. The method additionally can include generating a variable seed density prescription map using the NDVI* map. The variable seed density prescription map can be spatially defined.

Several embodiments can include a system for prescribing variable seed density planting. The system can include one or more processing modules and one or more non-transitory memory storage modules storing computing instructions configured to run on the one or more processing modules and perform one or more acts. The one or more acts can include obtaining first EOS data collected approximately on an estimated day (DOY′) during a past crop-growing season in which NDVI* data most closely resembles a spatial-yield pattern measured during harvest in the past crop-growing season. The one or more acts also can include converting the first EOS data to first reflectance data and first NDVI data. The one or more acts additionally can include calculating first NDVI* data on a per pixel basis for the first EOS data based on the first NDVI data using satellite scene statistics of the first EOS data. The one or more acts further can include generating an NDVI* map for a first field using the first NDVI* data for the first EOS data. The one or more acts additionally can include generating a variable seed density prescription map using the NDVI* map. The variable seed density prescription map can be spatially defined.

In a number of embodiments, the systems and methods described herein can facilitate and/or perform variable density planting of seed optimized to the spatially-variable soil capability of each field. Using EOS data, each crop type in each region can be calibrated to determine when, during the growing season, the spatial variability of yield indicative of soil capability can be displayed by that crop type in a particular region having substantially the same climate and day length characteristics. This calibration can be used to determine when to obtain EOS snapshots to portray the yield pattern on each field. A map generated from a prior year(s) for this pattern can be used to optimize variable seeding density across the field through linear interpolation. The resulting prescriptions then can guide variable density seed planting, potentially across vast farmed regions.

In many embodiments, a time-specific snapshot of remotely sensed data taken at a time certain well in advance of harvest that displays the pattern of yield across the field can be used. The timing for this snapshot can be forecasted for each field based upon relationships calibrated for crop type and region using a method that clocks the development stages of the each cropped field. The remotely-sensed measure of yield variability can be determined using a vegetation index, NDVI*, that can be calibrated to remove confounding effects from the soil background and atmospheric effects. The resulting timed NDVI* map can provide a surrogate for relative yield that can be used to scale the application density of the desired input, such as seeds.

In a number of embodiments, the systems and methods described herein can provide a remotely-sensed surrogate of yield to make seed density prescriptions simply and accurately. Conventional densities for seeding combined with the systems and methods described herein can facilitate variable density seeding for widespread agricultural use. The systems and methods described herein can combine remote sensing, particularly using Earth observation satellite data (EOS) and computer automation, to rapidly deliver seed prescriptions to farmers at low cost across thousands of square miles. In some embodiments, EOS data also can includes data collected from manned and unmanned aircraft because, like EOS data, they are viewing the earth from above, only closer to the service.

There can be two major parts in the process of variable density seeding: the first part can be deriving a map to guide the variable density application, and the second can be implementing this prescription upon the field. The second part for this process can be done using conventional methods using various machines to accomplish varying the seeding density. The first part of deriving the map can involve development of data to represent the spatial soil capability on across the field.

Spatial soil capability can be derived using data from soils mapping. U.S. Department of Agriculture maps can be very general, as they were generally developed through extrapolation from relatively few points, and can be incapable for differentiating soil capability at a sufficiently fine resolution to guide variable density inputs such as seeding. Maps can also be derived using data from yield measured at harvest with technology available on farm equipment to assist generating maps based upon yield. Yields are measured during harvest with equipment that monitors the rate of intake of harvested grain for known positions in the field established by GPS during harvesting. Basing maps of soil capability on yield for varying seed populations can be result in inherently inaccurate yield measurements due to improper calibration, buildup of material that prevents accurate readings, cutting crops within partial width of the harvester intake, wear on the equipment, highly variable grain moisture content, and harvesting on slopes.

Variable density fertilizer application using EOS data in one embodiment without correcting the soil background in EOS data can induce considerable and highly variable error for NDVI values across fields with little or no vegetation cover, which can make the crop development stage difficult to be determined from early season measurements when the crop cover is incomplete and the soil surface is exposed. NDVI values can be highly influenced by reflectance of soil before the canopy closes. The use of bare soil reflectance as maps of soil brightness can be a poor index upon which to judge soil properties for supporting variable density seeding because surface soil water content can be unrelated to soil capability, yet can have a controlling influence on soil brightness. Highly reflectant exposed crop residue can have a profound effect upon soil brightness that bears no relationship to the underlying soil properties. Neither surface soil water expression nor exposed crop residues can be correlated to soil properties that create soil capability or support yield. Determining when to obtain EOS data for determination of yield patterns can have a significant impact. For example, timing the EOS snapshot for assessing spatial patterns as a period during the crop's last vegetative state, which in the U.S. corn belt is from mid-July to mid-August, can result in an erroneous mapping of spatial yield and resultant deficiencies in a seeding prescription determined from it.

Operational Remotely-Sensed Seed Density Prescription

In many embodiments, remote sensing with EOS data can be a practical solution for variable prescription of seed density optimized to the variable soil capability across a field. The accuracy desired for such precision prescription can be achieved using systems and methods that correct for the confounding effects of atmospheric aerosols and soil background, which can advantageously enable evaluation of crop canopies through the growing season and comparison from year to year. Such seasonal curves, in turn, can enable measuring crop stages using EOS data, alone. In several embodiments, the systems and methods described herein can enable calibrating and then forecasting when the spatial-yield pattern can be displayed by the crop canopies during a brief several-week period each year.

In a number of embodiments, the systems and method described herein can satisfies various criteria for remote sensing-based precision agricultural guidance for variable density seed planting prescription and application:
1. For economic practicality, the method can be based upon the use of EOS data, which can allow it to be applied across large regions.
2. A vegetation index, such as NDVI, can be used for assessing the vigor of the crop spatially across the field.
3. The vegetation index can be correction for atmospheric and soil background effects that add significant error to the signal that represents crop vigor.
4. For operational practicality, each EOS scene can have atmospheric and soil background effects removed entirely using scene statistics, rather than requiring at-ground measurements.
5. The spatial-yield pattern can be detectable using EOS data within a specific time during the development, and growth of the crop and the timing of this display can be known and forecasted for each crop type (e.g., corn, soybeans, sorghum, etc.).
6. The crop development stage can be established using EOS data in order to determine when to time the EOS imagery to assess spatial yield.
7. To understand when to acquire EOS data for assessing the spatial distribution of yield, each crop type can first undergo calibration to determine when patterns of yield measured at the time of harvest are detectable in the EOS data. Datasets of spatial yield measured at harvest can be acquired for this calibration.
   In some embodiments, the systems and methods described herein can satisfy all seven criteria, which can beneficially make a spatially-defined variable-seeding-density prescription optimized to the soil capability across a field based upon EOS data. In other embodiments, the systems and methods described herein can satisfy one or more of the seven criteria.

Correcting NDVI from Atmospheric and Soil Background Effects

Even though soil capability often can be variable throughout a given field, most farmers plant the same seed density across their fields, which can result in a waste of money and possibly even a loss of yield through the competition for limited resources in soils with poor capability. Where there is much higher soil capability, the potential exists to enhance yield through higher density of plants. Remote sensing can advantageously facilitate optimizing the seeding rate for a field.

The yield of a crop can be determined by its health and can be indicated by the greenness of the crop. Expression of greenness can be dependent upon the capability of the soil and enhancement through inputs made by the farmer. Soil capability can determine the density of plants that can be maintained at many locations throughout the cropped field. Remotely-sensed crop greenness can be portrayed by vegetation indices that can combine red and near infrared light from EOS data. Greenness, a term used here by convention, makes sense to the visual world, but paradoxically can be most accurately determined using reflected red light that is inversely proportional to the green vigor of the canopy. Plants appear green because chlorophyll strongly absorbs red light in the act of photosynthesis; green is simply what is not used and reflected back and visible to the human eye. Crop canopies reflect highly in the near infrared, as do many background surfaces, a common example being dry soils. However, the ratio of red versus near infrared light enables the use of vegetation indices to measure plant canopy vigor. NDVI is the most commonly used among such indices, as provided in Equation 1.

$$NDVI = \frac{NIR - Red}{NIR + Red} , \qquad ( Equation 1 )$$

where NIR is the near infrared reflectance and Red is the red reflection within the digital data commonly measured by sensors borne on EOS platforms.

In its role as an estimator of canopy greenness, NDVI can be insufficiently accurate for use in precision agriculture due to confounding soil background reflectance and atmospheric aerosol effects of scatter and attenuation. Both effects can alter the plant vigor signal in NDVI. In many embodiments, the accuracy for NDVI to portray vegetation vigor can be enhanced by conversion to NDVI* that can stretch the NDVI values from zero to one to represent the full range of vegetation greenness from none to saturated as portrayed in EOS data. NDVI* can outperform all vegetation indices commonly used in the field of remote sensing. Conversion of NDVI to NDVI*, as provided in Equation 2, can correct for the error-inducing effects from soil background and atmospheric aerosols to provide accurate scaled index values appropriate for application to precision agriculture.

$${NDVI}^{*} = \frac{{NDVI}_{i} - {NDVI}_{0}}{{NDVI}_{S} - {NDVI}_{0}} , \qquad ( Equation 2 )$$

where NDVIᵢ is the measured NDVI for the ith pixel, NDVI_{S} is the saturated value for NDVI, and NDVI₀ is the NDVI value representing bare soil.

In a number of embodiments, NDVI* can be calibrated using scene statistics, and can involve no specific ground target or ground-based measurements. NDVI₀ can be the calibration for bare soil. There are times of the year when a maximally verdant target suitable for setting NDVI_{S} can be missing in the scene, for example, during spring and fall when a crops are becoming established or are senescing prior to harvest. In various embodiments, the NDVI_{S} value can be chosen as an empirical constant, as the peak value for non-cloudy scenes in an atmosphere relatively clear of aerosols occupies a known range that can be determined empirically. The choice of a set NDVI value to represent NDVI_{S} can produce insignificant influence upon the resulting NDVI* values.

NDVI of bare soil can be regionally variable with nearly all values greater than zero, sometimes considerably so (for example NDVI of 0.2). The NDVI₀ term in Equation 2 can correct for this elevated soil background. Without the soil background correction provided with NDVI*, crop response during a period critical to timing of the crop's seasonal growth and maturation can be unreliably measured using remote sensing.

Over time and in the absence of correction, rather than presenting an expected smooth growth curve, raw NDVI curves from growing crops can fluctuate in magnitude, often displaying an erroneous saw-tooth pattern due to variable atmospheric aerosol contents on the days that the images were collected. Aerosol effects can cause NDVI values to be depressed for images collected when atmospheric aerosol content is high. In several embodiments, NDVI* curves can correct this error to become relatively smooth as the crop progresses through the season. Because NDVI * can correct the NDVI signal for the effect of both atmospheric and soil background influences, it can enable remote sensing alone to perform a suite of useful agronomic analyses stemming from seasonal curves. For example, the phenologic stage of a cropped field can be determined from serial EOS snapshots converted to NDVI*. By contrast, NDVI can be unsuitable for this calculation due to the error it contains.

Clocking Function to Determine Crop Phenology

To be scalable across thousands of square miles and to be automatable, data for precision-agriculture input can be determined by remote sensing methods rather than relying upon record keeping and reporting (e.g., reporting by the farmer). Such manual reporting of critical information can be infeasible in practice because farmers can be extremely busy during the growing season and often cannot be relied upon to complete reporting when confronted by more immediate and pressing tasks. Advantageously, in a number of embodiments, an initiation date for each cropped field can be determined using NDVI* values collected through the first 45 days of the growing season for calculating a crop initiation point.

In several embodiments, determining an initiation point for a crop can enable clocking forward set numbers of days to predict growth stages according to math relationships determined by calibration for each crop type and farmed region. The term “region” as used herein can be defined as an area having substantially the same climate and a latitude within about three 3 degrees (about 200 miles).

For application to a farmed region, the clocking function can be determined using multiple EOS images. Data then can be extracted for calculations to represent conditions on each field growing a single crop type. A suite of multiple-date NDVI* values representative of the field can be accumulated through at least the initial approximately 45 days of crop growth. Either the field average or the field median can be extracted and plotted by day of year (DOY), incrementing from 1 to 365, to yield a time-wise crop growth curve that represents the field. These and other actions described herein can be completely automatable within the systems and methods described herein.

NDVI* can be a direct expression of the chlorophyll contained in the crop canopy. Like other allometric measurements of organisms (e.g., weight, length, etc.), growth of the crop and its photosynthetic capacity represented by NDVI*, describes a sigmoid or “S” shape. NDVI* forms an initial tail, followed by linear growth, followed by a plateau, therefore describing an S-shaped curve through the growing season, discounting the last stages of maturation and senescence with declining NDVI*.

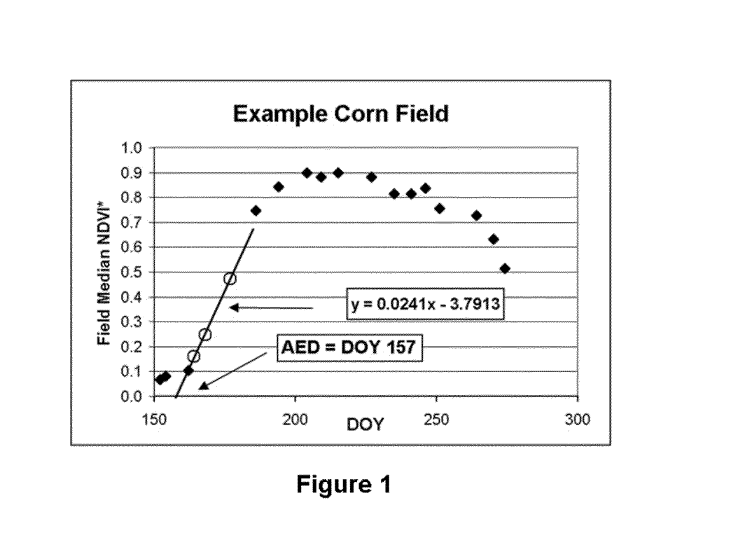

Turning to the drawings, FIG. 1 illustrates a chart showing representative median values for NDVI* from serial images that were extracted for an example corn field plotted by the corresponding day of year (DOY). FIG. 1 further illustrates a calibration action using linear regression and solving for y=0 to find the apparent emergence date (AED) for a corn field. The linear growth phase of crops expressed as NDVI* graphed on DOY can be used by the clocking function to determine an initiation point, termed the apparent emergence date (AED) for each field. Working within automation, in a number of embodiments, the clocking function can collect and store values of NDVI*, for example between approximately 0.15 and approximately 0.6 (NDVI* is dimensionless) for each field at known DOY during the initial approximately 45 days of crop establishment. For each field, the program next can perform linear regression of the collected NDVI* values, as y, on DOY values, as x, and solves for NDVI*=0 in the resulting linear equation. The DOY predicted at NDVI*=0 can be the AED of each field, as shown in FIG. 1. The AED for each field can permit calibrating and then forecasting the DOY of all growth stages in terms of elapsed days from AED.

In a number of embodiments, the clocking function combined with known growth stages for each field can permit calibration against AED to forecast when to perform treatments vital to the health and yield of the crop. For example, corn can be frequently fertilized at planting and again before tassel formation. The time of tasseling can be predicted accurately when calibrated as elapsed days from AED.

The initial tail of the sigmoid NDVI* crop growth curve, as shown in FIG. 1, can be affected by water status, temperature, or a combination of both. Water can be generally sufficient for crops during the initial part of the growing season because crop usage and evaporation tend to be low and soil water storage tends to be high, either from irrigation or accumulation of winter and spring rain. Given sufficient water for germination and establishment of cultivated crops, the initial tail of the sigmoid curve generally can be most affected by temperature, with cold temperatures delaying growth.

To account for the initial tail of the growth curve and the role played by the delaying effect of low temperature, conventional calculation and accounting of heat units, also called growing degree days, can be used. Heat units can involve cumbersome entry and tracking of temperature data, with mathematical calculations made from these data for each field and each crop type. In several embodiments, the clocking function can bypass the initial temperature-impaired tail of the growth curve by clocking the crop during its linear growth phase. The linear phase can begin when the crop is no longer affected by growth-limiting temperatures. In various embodiments, the clocking function can calculate a theoretic point when temperature-limited growth has passed and the linear growth period has begun, which can obviate the need to include heat units in phenology calculations. In many embodiments, the clocking function can enable assessment of the phenology on many individual fields across tens of thousands of square miles covered by EOS data and can do so without reference to temperature.

NDVI*, A Surrogate for Spatial-Yield Patterns

As an expression of canopy chlorophyll, NDVI* can be an indicator of potential crop yield. Chlorophyll is a metabolically expensive molecule that is conserved—no excess of chlorophyll is produced in plants, including crops. The function of chlorophyll is photosynthesis that provides the carbohydrate feedstock for all biochemical processes in the plant. The higher the rate of photosynthesis and attendant biochemical processes in the crop canopy, the higher the yield. Therefore, NDVI* magnitude can be a direct indicator of photosynthesis and crop yield. The NDVI* magnitude can be controlled by soil capability inclusive of hydrology and physical and chemical conditions that are all influenced by topography. Thus, with all other factors being equal in the cultivation of a crop (e.g., seed density and fertilization), the pattern of NDVI* expressed by a cropped field can be an indicator of the spatial pattern of potential yield created by soil capability.

Crop spatial-yield patterns largely can be determined by the health and vigor of the crop canopy expressed as NDVI* magnitude. For an individual field, the spatial-yield pattern can be demonstrated through snapshots of NDVI* when taken at a specific time in the growing season that is first determined through calibration. Once the timing is known, it can be targeted for EOS data collection using the clocking function. For example, in several embodiments, the spatial-yield pattern in corn can be assessed with single EOS snapshots taken during a certain time window predicted using an elapsed interval relative to that field's AED. For corn, this window for display of NDVI* as a surrogate for yield can occur in the latter period of crop growth but well in advance of senescence. The forecasted day when the spatial-yield pattern is best displayed by NDVI* can be designated DOY′.

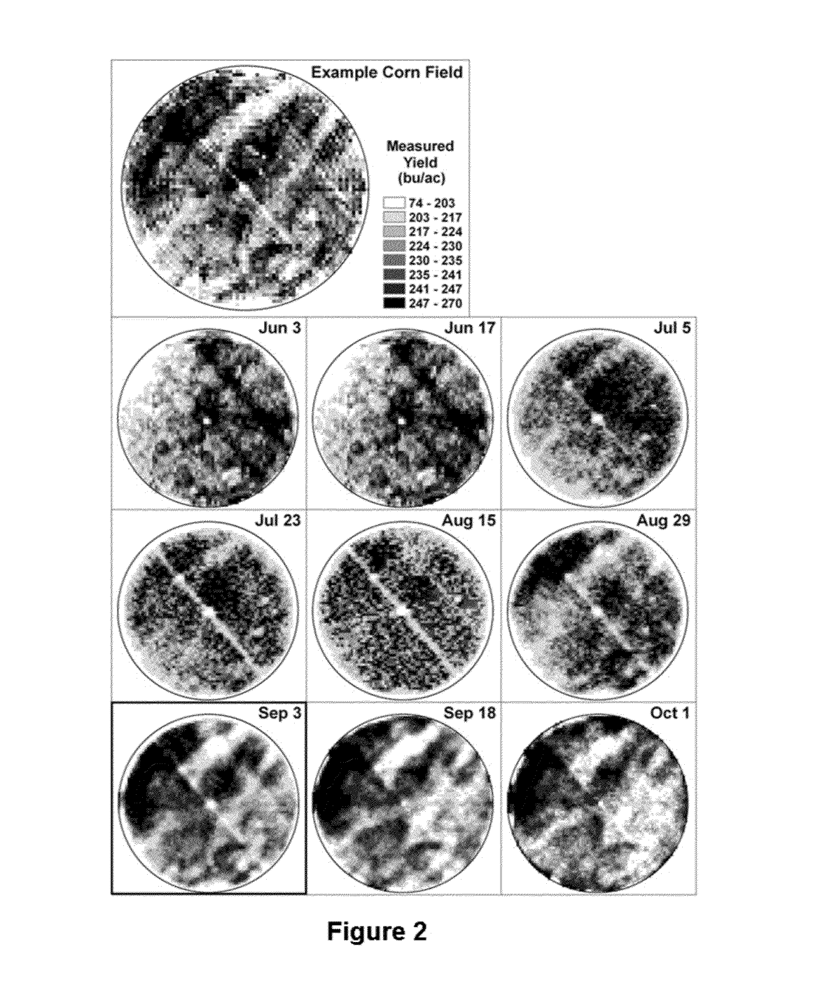

Turning ahead in the drawings, FIG. 2 illustrates an exemplary time series of NDVI* images to calibrate the elapsed days from AED for the best signature of yield from EOS data (September 3) for the yield measured during harvest of a corn field. In many embodiments, the clocking function for various crop stages can be calibrated for each crop type using historic data through a set series of actions for both operational application and calibration. For each field with known crop type λ, NDVI* maps can be developed for images obtained through the growing season as shown in FIG. 2. These maps then can be compared visually to the pattern of yield obtained during harvest by devices that measure the flow rate or weight of the harvested crop according to geoposition provided by an onboard GPS system. A sufficient proportion of farms currently gather such spatial yield data using systems that are sold with modern harvesting equipment, which can provide spatial yield data for calibrating all crop types. For calibration to forecast DOY′, a technician can identify and record the DOY of the NDVI* map that best exemplifies the spatial-yield pattern measured at the time of harvest. This process can be repeated for many fields to create a statistical sample for calibration for the number of elapsed days from AED to DOY′. The DOY′ to represent the spatial-yield pattern in corn generally occurs from 45 to 60 days prior to harvest.

In a number of embodiments, both the measured yield and NDVI* in FIG. 2 can be portrayed as quantiles having equal-sized frequency distribution bins. Quantile binning can provide greater contrast than percentile bins, which can contain equal-sized steps regardless of the frequency each step contains. Although either binning method can be used, quantiles can beneficially provide better visual calibration of the clocking function to determine DOY′. For the example corn field shown in FIG. 2, DOY′ was predicted through calibration to be September 7. In FIG. 2, September 3 was the closest image available to DOY′ to express crop yield, and thus can be the choice for the application to assess spatial yield on the example field.

In some embodiments, calibrating the clocking function to predict DOY′, as in FIG. 2, is an action that can involve human viewing of the crops spatial-yield patterns across the field. In an alternate embodiment, the calibration action to determine which date the NDVI* spatial pattern best expresses the measured pattern of spatial yield also can be automated using pattern recognition software. For comparison, FIG. 2 is shown in grayscale, but the spatial patterns displayed in FIG. 2 can be greatly enhanced with the addition of color gradients. Color gradients can provide better visual discrimination for choosing the best EOS NDVI* snapshot to represent the pattern of measured yield.

The measured spatial-yield variability of the example corn field, which is the uppermost and largest of the FIG. 2 images, was restricted to a range from approximately 140 to approximately 270 bushels per acre, while ninety percent of the yield values fell within a narrower range, from approximately 185 to approximately 260 bushels per acre, representing only 28 percent of the possible distribution. For this example, the seeding prescription based upon the crop-canopy NDVI* can be highly precise since the yield values are in a relatively small portion of the potential distribution.

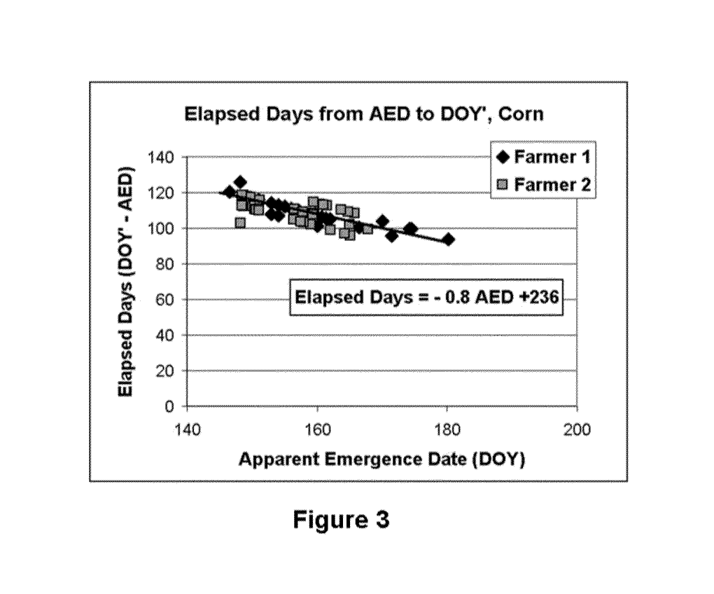

Turning ahead in the drawings, FIG. 3 illustrates a graph of elapsed days from AED for NDVI* to forecast a date for remotely sensed display of the spatial-yield pattern for corn, according to an embodiment. In many embodiments, collecting values of elapsed days to DOY′ versus AED for many fields can provide the second calibration action illustrated graphically in FIG. 3 that determines a relationship to predict elapsed days after AED to achieve DOY′. AED timing can be highly variable, even across a single given farmed region because the planting period can exceed two months. The relationship shown in FIG. 3 to forecast when the DOY′ will occur is beneficial because the elapsed period to DOY′ varies according to AED. A later AED that occurs when crops are planted later in the season can take less elapsed time to attain DOY′, as shown for corn in FIG. 3.

The reduction in the elapsed period from AED to DOY′, such as shown in FIG. 3, can be a function of crop development during periods with longer day length and warmer temperatures. The period for display of spatial-yield patterns for corn can occur over about two weeks bracketing the predicted DOY′. It should be kept in mind when attempting seasonal AED calibration, as in FIG. 3, that the apparent scatter in the values can partially result from the timing of the imagery. Cloud-free image availability can occur in intervals defined by the desired image periodicity as modified by cloud cover. Hence, for calibration, such as displayed on FIGS. 2-3, images may not always be available within the ideal timing for the period bracketing DOY′. This lack of images generally can be overcome, regionally, because the period for spatial display of yield can occur across a two week interval bracketing DOY′, while appropriate EOS data can be collected daily. Once the calibration derives the relationship, such as in FIG. 3, it can be used for that crop type in future years throughout the region of calibration. In many embodiments, each crop type in each region can need to be calibrated.

DOY′ NDVI* Maps for Variable Density Seed Prescription

The NDVI* map from an image at or close to DOY′ can be the input for prescribing and delivery of variable seed planting densities across a field. This NDVI* at DOY′ (hereafter, DOY′ can be inclusive of imagery obtained within the approximate two-week window for NDVI* spatial display of yield) can be used for variable density seeding prescription for the following year. In an alternate embodiment, the NDVI* at DOY′ from a number of previous years can be combined as a statistical sample to create a variable seeding prescription that potentially can remove or reduce the effect of patterns due to differential cultivation practices in any one year, whether intended or not (e.g., machine malfunction during planting, accidental double planting pass, malfunctioning irrigation systems, crop disease/pets, high rainfall, low rainfall, etc.).

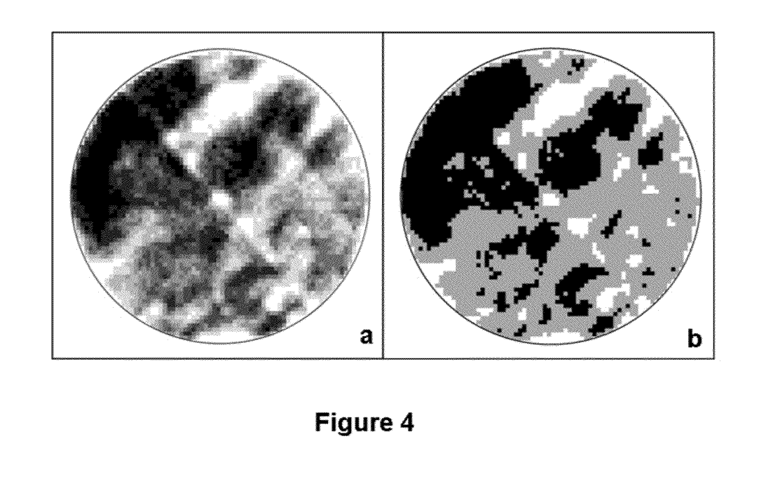

Turning ahead in the drawings, FIG. 4 illustrates eight quantile classes of NDVI* for an exemplary corn field, as shown in FIG. 4(a), that are reclassified into three percentile classes, as shown in FIG. 4(b), according to an embodiment. FIG. 4 provides two images of an NDVI* map that characterizes the spatial pattern of yield on the example field. FIG. 4(a) represents eight gray-scale classes of NDVI* for the September 3 DOY′ image of the example corn field. In both FIG. 4(a) and FIG. 2, grayscale portrayals of the example field's spatial NDVI* pattern at DOY′, light shading is low NDVI* while darker shading is high NDVI*. FIG. 4(b) presents three percentile (equal-sized bins) classes of NDVI*. In many embodiments, the NDVI* values that were used to generate FIGS. 4(a) and 4(b) also can be used to generate any number of classes, not just the three or eight shown. Likewise, these classes can be generalized and smoothed if too much complexity is shown. Conventional generalization functions for raster data can be useful for removing complex speckling such as can be seen on the one-third percentile representations of NDVI* in FIG. 4(b). Such speckling often can represent noise that arises due to the choice of bin sizes. Conventional smoothing functions can create rounded margins of class polygons interpolated through pixels that otherwise can impart pixilated rather than smooth margins. Both generalization and smoothing can assist in reducing impacts created by slight variations in geocorrection.

FIG. 4(b) presents the NDVI* map in three classes for the purpose of illustration because fewer classes enhance contrast for comparison of patterns. Employing more bins can impart greater precision and the limits of this precision can be defined by the inherent statistical properties of the data. The greatest source for error in correctly calculated NDVI* can be from geoposition, hence, the potential error in geopositional accuracy can be a consideration in choosing the number of classification bins. In the example shown in FIG. 4(a), the centers of the NDVI* classes shown are, low to high, 0.613, 0.696 and 0.778, for the exemplary corn field. This exemplary irrigated cornfield has level topography with little rainfall or soil variability, which can be factors supporting crop homogeneity. Greater heterogeneity in the NDVI* values across the field can be expected for dryland fields (in which water is supplied through rain alone), particularly in locations with high soil variability and topographic complexity. The choice of the number of classes can involve consideration of the capability of the farm equipment, the accuracy of the geoposition on the tractor, and uncertainty in the geoposition of the NDVI* map. In consideration of these variables, 10 seed density classes can be a likely maximum number.

If an entire field was treated in the same manner through the growing season, for example monolithic fertilizer application, seeding and watering, the pattern for yield represented by an EOS snapshot of NDVI* at DOY′ can illustrate the potential yield imparted by soil capability combined with topographic influences. For dryland cropped fields, in addition to the spatially variable soil physical and chemical properties, the yield pattern can also reflect soil hydrologic factors related to topographically-induced runoff, such as drainage from sloped ground and collection in swales and contour-furrow catchments. Swales and catchments present complexity for targeted seeding because they can receive sufficient water to support a crop during drought yet can drown the crop during a wet year. The same location of the field creating opposite results thus can depend upon the weather during the year in question. Such potential for differences in yield can be natural to dryland fields and can be understood and handled with appropriate adjustment. An editing feature to enable changing the seeding prescription on portions of the field can be used to overcome this dichotomy.

In addition to topography and soil capability, the expression of yield from a cultivated field, can be due to past treatments, residual fertilizer content, organic matter and other attributes that may not be equally influential across the field. Most agricultural fields are managed monolithically—supplied with seed and fertilizer evenly across the landscape. In many embodiments, the systems and methods described herein recognize differences across fields, such as those managed monolithically, in order to optimize inputs in a manner that enhances yield potential on all areas while conserving resources such as seed and fertilizer. Hence, the patterns that arise through the equal opportunity imparted by monolithic management can demonstrate the capability imparted solely by the soil and topography. After variable density prescriptions are made and operated for a time, in several embodiments, any change in the pattern of yield as displayed by NDVI* at DOY′ can be considered the norm and seeding prescriptions can be made based upon this new norm. The repeated application of the systems and methods described herein can advantageously provide a method to fine tune the seed prescription over time.

In many embodiments, the spatial-yield pattern for NDVI* measured at DOY′ can be reassessed at intervals of one to several years. Combining multiple years of NDVI* at DOY′ can yield an average pattern of soil-capability indicating relative values of NDVI* that can be more correct than that measured in a single year. Optionally, as a cost savings through omitting further service, the user (e.g., the farmer) can choose to reapply the same seeding prescription based upon assessments using the NDVI* map-based seeding prescription from a prior year. This latter option can be preferable if the NDVI* differences in the field are extreme and caused by highly divergent soil properties, such as a field that is dominated by productive soil but also contains non-productive soil in which remnant sand dunes have poor water and nutrient holding capacity. In several embodiments, a cogent strategy for this example can be to greatly reduce seed density on the remnant dune according to the NDVI* values. The reduction in seeding can reduce interplant competition to achieve a better yield, even with reduced plant density. In many embodiments, such dichotomous choices need not involve multiple years of seeding prescription to understand the correct differential yield potential for the field.

In various embodiments, a consideration during calibration and application of the systems and methods described herein can be that differential cultivation practices on a cropped field can influence the spatial pattern of NDVI* and can prevent the true crop canopy expression of soil capability that is of direct interest. For first-time application of the systems and methods provided herein, a field should exhibit the spatial-yield pattern imparted by the soil and water available to the crop. To best display this pattern, the entire field can be treated in the same manner: coincidental and equal planting, fertilizing, irrigation (if irrigated), etc. The exemplary corn field was treated monolithically, which enabled the coherent data in FIGS. 1-4. As occurred in the exemplary corn field, for discrimination of the patterns of yield-inducing soil properties of each field, if irrigated, then, in several embodiments, the entire field should be irrigated in the same manner. Otherwise, the resulting pattern expressed at DOY′ can be a mix of the pattern imparted by the physical capability to support yields, combined with any spatially-variable water application, which potentially can create patterns of zonation partially determined by the method of irrigation. If that pattern of irrigation is induced, such as by differences in water pressure due to changes in elevation across the field, and no actions are planned to correct this condition (e.g., not installing equipment for water pressure equalization), then this pattern can be taken to be the usual condition for the field operated in that manner. In this case, the resulting spatial seed density prescription can be representative of the stable management conditions that occurred in the past and are expected in the future, even if suboptimal. For the systems and methods described herein, in several embodiments, the seeding density therefore beneficially can be optimized to the field's soil-and-cultivation system and not just the soil capability.

In a number of embodiments, if the entire field is cultivated and managed in the same manner, the spatial-yield pattern can be a competent indicator of the spatially-variable soil capability within the field. Like spatial differences in crop culture, the spatial-yield pattern and its surrogated NDVI* also can be altered by any impact that does not affect the entire field equally (e.g., hail, crop pests, or diseases). Understanding the past influences upon the crop canopy during the growing season or during prior years can provide a benefit when applying the systems and methods described herein. Hence, the most experienced and knowledgeable person, the farmer, can be a target of the systems and methods described herein. In this specification, “farmer” can refer to the person managing a field or causing it to be managed.

In many embodiments, the DOY′ NDVI* maps, such as shown in FIG. 4, combined with the clocking function that forecasts when to acquire the DOY′ to create these products, can be meaningful output that can enable the systems and methods described herein. This output can permit mathematical guidance of variable densities of planted seed optimized to the spatial variability across each field. In several embodiments, the exact seeding density can be guided by the magnitude of the pixels within the surrogate spatial-yield pattern of the DOY′ NDVI* map. Through application program interfaces (APIs), digital maps, such as those portrayed in FIG. 4, can facilitate scaling and applying different seed densities across the field by controlling farm hardware that can meter seeds at the spatially-variable densities prescribed. Virtually all manufacturers of farming equipment that are guided by software and GPS provide APIs in order to enhance the utility for their hardware.

In many embodiments, the electronic data for the NDVI* map can contain spatial information to guide seed application densities according to geographic position provided by GPS on board the farm equipment. Conventional spatial positioning can be used on farm equipment manufactured with integral GPS systems to enable precision agriculture operations such as variable density seeding. In several embodiments, conventional controller technology for metering seeds can be used for tractor-pulled equipment. The systems and methods described herein can provide a suite of mathematical data upon which to vary the seed density spatially, which can beneficially transform an average farmed field of crops into a cropped field that has been optimally seeded in order to provide the highest return for the lowest input cost. This seeding can occur through instructing the controller for spatially variable seeding according to the NDVI* map at positions determined from the GPS system onboard and integral to the seeding equipment.

In many embodiments, the systems and methods described herein can (1) provide variable densities of seed planted to match the variable conditions within each field, (2) evaluate many fields at a time for this variable density application using automated software, (3) deliver the analysis to the farmer through the Internet, (4) provide for simple manipulation of the output by the farmer within software, and/or (5) control farm hardware to apply the seeding prescription throughout each field. In some embodiments, each of the five aforementioned characteristics are included.

In a number of embodiments, the systems and methods described herein can be enabled by harnessing NDVI* growth curves to establish surrogate spatial-yield patterns. Three exemplary options for application of the systems and methods described herein are discussed below, each delivered through Internet connectivity in software that harnesses the knowledge and experience of the farmer and the companies that supply the seed. Other options can be employed in many different embodiments or examples not specifically depicted or described herein. For each of three options described, variable densities of seeding can be applied to the field according to the software operating through APIs to control the equipment of the farmer. Variable density seeding is relatively new, and ways to use variable density prescriptions, and what they should be, are still being determined, chiefly by the companies that grow and sell seed. Thus, the options are described herein as examples of the various methods for applying the DOY′ NDVI* maps that can be used for optimal prescription in various embodiments.

In Option 1 the farmer can allow the software to estimate the seeding density for the field, based solely upon the DOY′ NDVI* map and a peak seeding density for the crop type. For example, 42,000 seeds per acre for corn is an approximate maximum density that is provided by a leading seed company. Using this upper limit for Option 1, the software then can assign 42,000 seeds per acre to correspond with the theoretic high value of one for NDVI*. For this option all pixelwise values of NDVI* then can be scaled from this high down to a theoretic low value of zero seeds per acre at zero NDVI*, although, in many embodiments, no zero potential should exist in a cultivated field. For cultivated fields, in several embodiments, the seeding density will typically be bunched within the range for the DOY′ NDVI* map from approximately 0.4 to approximately 0.9, which correspond to lowest and highest values of NDVI* expected for a competently cropped field at DOY′. The linear scaling method with a high value of 42,000 seeds/acre at the NDVI* equal to one and a zero seed at zero NDVI* low value yields a density of from 16,800 (at NDVI* of 0.4) to 37,800 seeds per acre (NDVI* of 0.9). These values are commensurate with seeding densities published in the literature published by the aforementioned seed company.

In Option 2, the farmer can choose the maximal seeding density for the field based upon experience. The software then can pair the maximum measured DOY′ NDVI* for the field with the maximum set by the farmer and can scale a linear relationship between this maximum to the low point, zero seed at zero NDVI*, as in Option 1 for scaling the remainder of the field.

In Option 3, the farmer can choose the maximum and minimum seeding densities for the field. The software then can find the statistical maximum and minimum in the field and can calculate the various relative seeding densities in between the two bracketing values.

For each of the three options described, in several embodiments, the software can show the seeding densities according to the classes of DOY′ NDVI* on the field, from lowest to highest. The densities from the selected option can be compared to the other two options for the farmer to examine and then ratify, or make adjustments. In many embodiments, the software can provide a color-keyed map of the seeding prescription for each option. There are many potential adjustments for combining software algorithms and the DOY′ NDVI* map to determine seeding density. In some embodiments, for example, a simple add-on to the software can include economic calculators for the cost of seed and other inputs necessary for growing a competent crop.

In several embodiments, the digital data associated with choosing seeding options and the spatially-variable densities of seeds planted on each field can be stored data that advantageously can establish a history for that field. In many embodiments, these data can be called up through software and compared across years. In a number of embodiments, this digital history can be used to readily identify a field's spatial soil capability and topographic control of hydrology.

In many embodiments, the NDVI* map from one crop type grown in a previous year can be used for determination of the seeding density of another crop in the following year. In various embodiments, this NDVI* map reuse is available because the spatial pattern of NDVI* represents the soil capability that can affect the growth of any crop. In some embodiments, the seeding should follow the recommendations for the intended crop type according to the seed company or experience of the farmer as in Options 1, 2 or 3, for example.

In several embodiments, the stored history for a field of interest through software can support calculation of the potential return on investment and avoid seeding, fertilizing, and irrigation of zones that may repeatedly fail to provide a return or to reduce inputs such as seed to a point that a return on investment can occur. In many embodiments, assessment of potential return on investment can be made with only limited data on the cost of inputs to attain a crop (e.g., costs for seed, fertilizer, soil ameliorants, diesel, general wear and tear on the farm equipment performing the planting, and financing costs). In various embodiments, such data can be kept for each farmed region and can be updated automatically through an Internet connection. In a number of embodiments, decisions can be presented to the farmer for zones within the field that can best assure return on investment. Similarly, in several embodiments, the software can forecast yields and return on investment. In various embodiments, the systems and methods described herein can provide a decision support role in which the potential value of the yield can be assessed against input costs.

Flow Charts

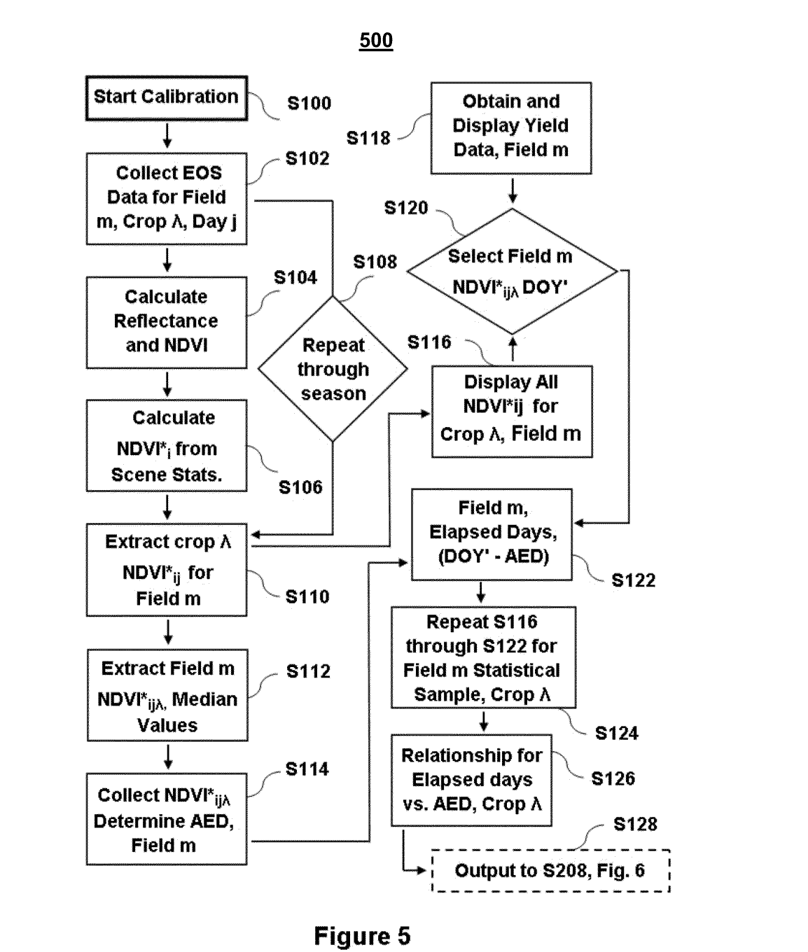

Turning ahead in the drawings, FIG. 5 illustrates a flow chart for a method 500 of calibrating the clocking function for a crop, which can be used determine when to acquire an EOS snapshot of the field to represent the spatial pattern of soil capability, according to an embodiment. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped.

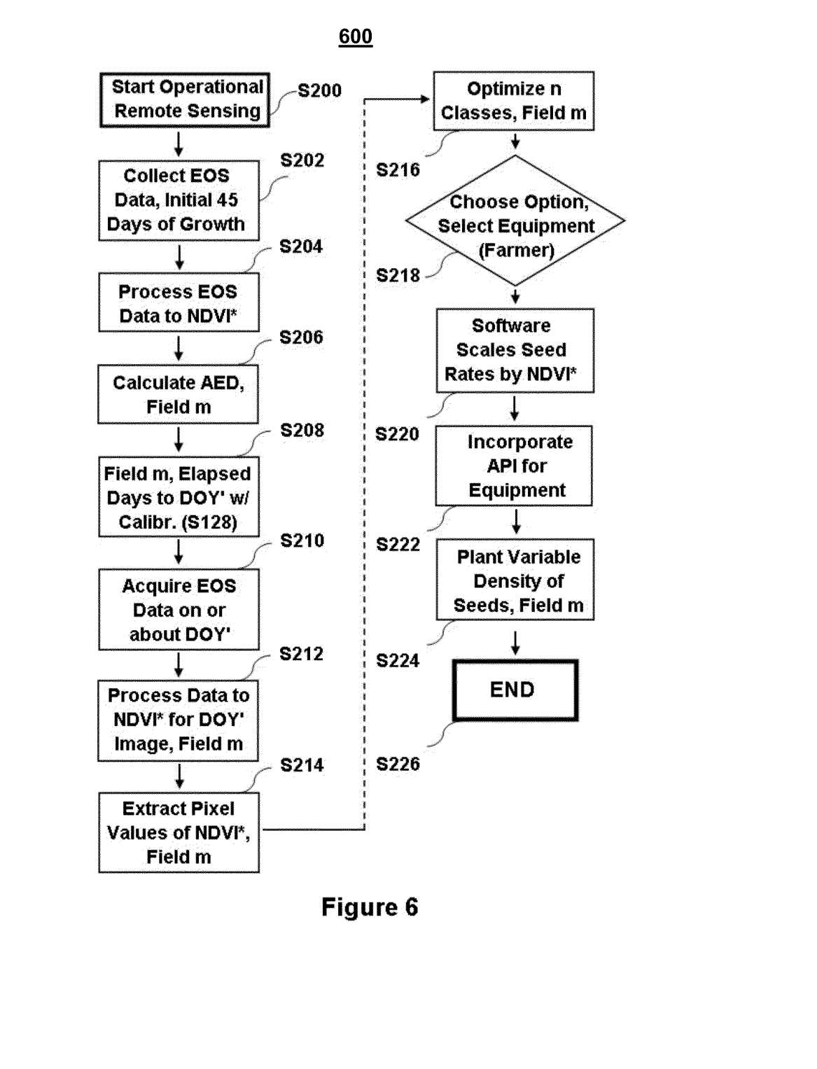

The conventions used in FIG. 5 and FIG. 6 (described below) are:

λ refers to crop type,
j refers to the jth day, which for EOS data, is the day of the overpass,
i refers to the ith pixel,
m refers to the mth field, and
n refers to numbers of samples.

Referring to FIG. 5, method 500 of calibration can begin at a block S100 of starting calibration. In many embodiments, calibration for all crop types can begin at block S100.

In a number of embodiments, method 500 next can include a block S102 of collecting EOS data. In several embodiments, EOS data can be collected for all jth days for crop λ for Field m. Images can be obtained through the growing season, such as obtained about one week apart, for calibrating the clocking function for each crop type.

In several embodiments, method 500 next can include a block S104 of calculating reflectance and NDVI. For example, the images can be converted to reflectance and NDVI as described above.

In many embodiments, method 500 next can include a block S106 of extracting NDVI scene statistics and calculating NDVI* based on these statistics for each pixel across the EOS image.

In some embodiments, method 500 can include a decision block S108 that designates that EOS data can be continually gathered and processed throughout the growing season. Decision block S108 is designated as a decision block in recognition that image collection can involve decision for when and how often images will be needed.

In various embodiments, method 500 next, after block S106, can include a block S110 of extracting NDVI* pixel data for a specific crop type λ on Field m.

In many embodiments, method 500 next can include a block S112 of extracting median values of NDVI* for Field m. The median values can provide a statistical representation of the sample. Median values tend to be more robust indicators of field trends than averages. In other embodiments, averages can be extracted.

In a number of embodiments, method 500 next can include a block S114 of collecting field medians together to represent the growth of the crop through the season and determining the AED for each Field m. For example, the AED can be determined using the graphical method shown in FIG. 1 and described above.

Returning to block S110, in some embodiments, the flow can proceed to a block S116 of displaying visual displays of the NDVI* across Field m.

In several embodiments, method 500 can include a block S118 of obtaining and displaying the yield measured at the time of harvest across Field m.

In some embodiments, method 500 next can include a decision block S120 of visually comparing the displays from block S116 and block S118 to select the image date that best matches the measure spatial expression of yield, at or near DOY′.

In various embodiments, the flow can proceed from block S114 and/or decision block S120 to a block S122 of determining an estimate of elapsed days. In many embodiments, the AED value determined for Field m in block S114, as expressed as DOY, can be subtracted from the selected approximate DOY′ date of the imagery to determine the estimate of elapsed days.

In many embodiments, method 500 next can include a block S124 of repeating blocks S116 through S122 to create a statistical sample to calibrate elapsed days to DOY′ from AED.

In some embodiments, method 500 next can include a block S126 of estimating the elapsed days to DOY′ from AED according to the AED of Field m. For example, the pooled values collected in block S124 can be fitted with a linear relationship using regression, such as using the graphical method illustrated in FIG. 3.

In several embodiments, the calibration actions in blocks S110 through S126 can be repeated for each crop type λ. In a number of embodiments, the mathematical relationship from block S126 for each crop type λ can be output to a block S128, and the output can be used in block S208 of FIG. 6, described below, for use in forecasting when the spatial-yield pattern at DOY′ occurs for fields that are evaluated.

Turning ahead in the drawings, FIG. 6 illustrates a flow chart for a method 600 of operational remote sensing for planting a field, according to an embodiment. Method 600 is merely exemplary and is not limited to the embodiments presented herein. Method 600 can be employed in many different embodiments or examples not specifically depicted or described herein. In some embodiments, the procedures, the processes, and/or the activities of method 600 can be performed in the order presented. In other embodiments, the procedures, the processes, and/or the activities of method 600 can be performed in any suitable order. In still other embodiments, one or more of the procedures, the processes, and/or the activities of method 600 can be combined or skipped. Referring to FIG. 6, method 600 of operational remote sensing can begin at a block S200 of starting field scouting.

In a number of embodiments, method 600 next can include a block S202 of collecting EOS data during the linear phase of the NDVI* growth curve for each Field m. For example, the linear phase can be similar to the linear phase shown in FIG. 1.

In several embodiments, method 600 next can include a block S204 of converting the linear growth phase data to NDVI*. In a number of embodiments, block S204 can follow the individual actions included in blocks S102 through S106 of FIG. 5.

In some embodiments, method 600 next can include a block S206 of estimating AED for each Field m of crop type λ. In many embodiments, the NDVI* values within the linear growth phase for crop λ can be processed using the linear regression calibration procedure of the clocking function, as shown in FIG. 1, to estimate AED for each Field m of crop type λ.

In a number of embodiments, method 600 next can include a block S208 of estimating when the spatial-yield pattern will naturally be displayed by Field m. In many embodiments, block S208 can receive the output of the relationship for the number of elapsed days for displaying the spatial-yield pattern (DOY′) that was output from block S128 in FIG. 5

In some embodiments, method 600 next can include a block S210 of acquiring EOS data for Field m to represent the spatial-yield pattern approximately on the DOY′.

In various embodiments, method 600 next can include a block S212 of processing the spatial-yield pattern image for DOY′ to determine NDVI*.

In several embodiments, method 600 next can include a block S214 of extracting pixel values for NDVI* for Field m.

In some embodiments, the flow can continue to a block S216 to begin preparation for planting Field m. In many embodiments, method 600 can include block S216 of optimizing the analysis for n classes of Field m. In several embodiments, this analysis can choose the number of classes in consideration of the variability of the NDVI* map of Field m and the breadth of the NDVI* values. This optimization can be done using software. In some embodiments, the number of classes can be set by the user (e.g., the farmer) as long as the precision of the data will support the number of classes chosen.

In many embodiments, method 600 next can include a decision block S218 of the user (e.g., the farmer) selecting the settings desired, such as which option of the three options and the intended piece of farm equipment for planting the variable seed density prescription. The appropriate farm equipment, also known as a planter, should have the capability to vary the seed density according to software input.

In various embodiments, method 600 next can include a block S220 of scaling the seeding density for the various zones in the field according to the choice made in decision block S218 to provide a variable seed density prescription.

In several embodiments, method 600 next can include a block S222 of transferring the variable seed density prescription through the API to the planter equipment. Many planters are now manufactured with variable density capability and integral GPS units, and can be used to apply the prescription for spatially variable planting of seed density. Modern farm hardware generally include APIs to allow software to designate the variable seed density prescription. The APIs generally contain a set of routines, protocols and tools for building such software applications.

In a number of embodiments, method 600 next can include a block S224 of planting the seed using the equipment using the variable seed density prescription. At a block S226, the flow can end.

Not shown within the flowcharts is the development of NDVI* maps in subsequent years, and back-comparison with results from prior years. Such back-comparisons can be instrumental in establishing a permanent planting prescription to be used on the field. Back comparison can provide for fine tuning the seeding prescription. In many embodiments, such reevaluation and course corrections can be performed using the systems and methods described and conventional methods of managing agricultural fields. Software applications for this reevaluation can be built into multi-year functionality within the operational software. In other embodiments, the same or similar actions as those shown in the FIGS. 5-6 can be followed in subsequent years in order to assemble the data for such multi-year comparisons.

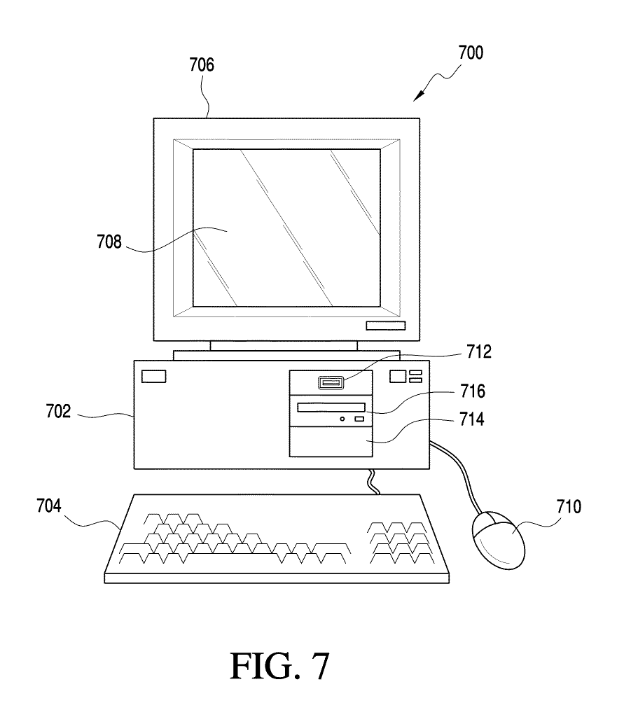

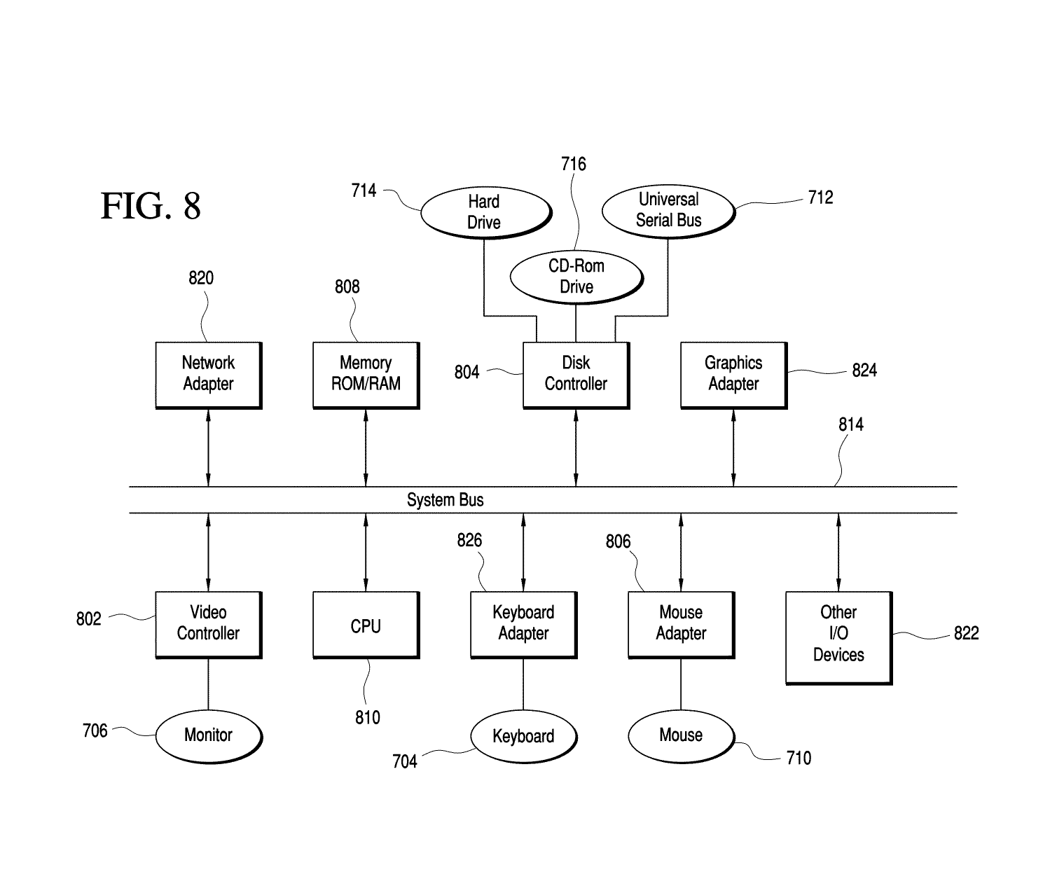

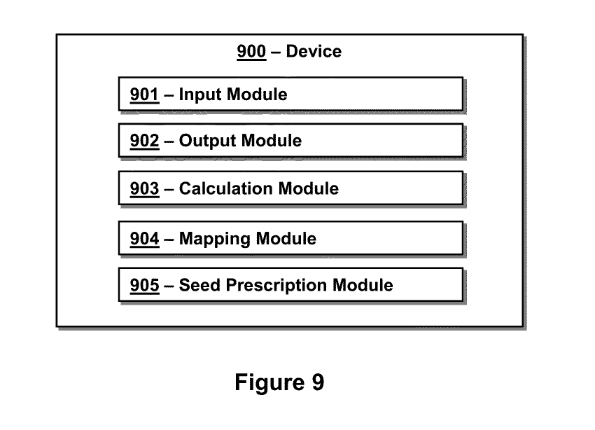

Turning ahead in the drawings, FIG. 7 illustrates a computer system 700 that is suitable for implementing device 900 of FIG. 9, described below. Computer system 700 includes a chassis 702 containing one or more circuit boards (not shown), a USB (universal serial bus) port 712, a Compact Disc Read-Only Memory (CD-ROM) and/or Digital Video Disc (DVD) drive 716, and a hard drive 714. A representative block diagram of the elements included on the circuit boards inside chassis 702 is shown in FIG. 8. A central processing unit (CPU) 810 in FIG. 8 is coupled to a system bus 814 in FIG. 8. In various embodiments, the architecture of CPU 810 can be compliant with any of a variety of commercially distributed architecture families.

Continuing with FIG. 8, system bus 814 also is coupled to memory 808 that includes both read only memory (ROM) and random access memory (RAM). Non-volatile portions of memory storage unit 808 or the ROM can be encoded with a boot code sequence suitable for restoring computer system 700 (FIG. 7) to a functional state after a system reset. In addition, memory 808 can include microcode such as a Basic Input-Output System (BIOS). In some examples, the one or more memory storage units of the various embodiments disclosed herein can comprise memory storage unit 808, a USB-equipped electronic device, such as, an external memory storage unit (not shown) coupled to universal serial bus (USB) port 712 (FIGS. 7-8), hard drive 714 (FIGS. 7-8), and/or CD-ROM or DVD drive 716 (FIGS. 7-8). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise Microsoft® Windows® operating system (OS), Mac® OS, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 810.

In the depicted embodiment of FIG. 8, various I/O devices such as a disk controller 804, a graphics adapter 824, a video controller 802, a keyboard adapter 826, a mouse adapter 806, a network adapter 820, and other I/O devices 822 can be coupled to system bus 814. Keyboard adapter 826 and mouse adapter 806 are coupled to a keyboard 604 (FIGS. 7 and 8) and a mouse 710 (FIGS. 7 and 8), respectively, of computer system 700 (FIG. 7). While graphics adapter 824 and video controller 802 are indicated as distinct units in FIG. 8, video controller 802 can be integrated into graphics adapter 824, or vice versa in other embodiments. Video controller 802 is suitable for refreshing a monitor 706 (FIGS. 7 and 8) to display images on a screen 708 (FIG. 7) of computer system 700 (FIG. 7). Disk controller 804 can control hard drive 714 (FIGS. 7 and 8), USB port 712 (FIGS. 7 and 8), and CD-ROM or DVD drive 716 (FIGS. 7 and 8). In other embodiments, distinct units can be used to control each of these devices separately.

In some embodiments, network adapter 820 can comprise and/or be implemented as a WNIC (wireless network interface controller) card (not shown) plugged or coupled to an expansion port (not shown) in computer system 700 (FIG. 7). In other embodiments, the WNIC card can be a wireless network card built into computer system 700 (FIG. 7). A wireless network adapter can be built into computer system 700 (FIG. 7) by having wireless communication capabilities integrated into the motherboard chipset (not shown), or implemented via one or more dedicated wireless communication chips (not shown), connected through a PCI (peripheral component interconnector) or a PCI express bus of computer system 700 (FIG. 7) or USB port 712 (FIG. 7). In other embodiments, network adapter 820 can comprise and/or be implemented as a wired network interface controller card (not shown).

Although many other components of computer system 700 (FIG. 7) are not shown, such components and their interconnection are well known to those of ordinary skill in the art. Accordingly, further details concerning the construction and composition of computer system 700 (FIG. 7) and the circuit boards inside chassis 702 (FIG. 7) need not be discussed herein.

When computer system 700 in FIG. 7 is running, program instructions stored on a USB drive in USB port 712, on a CD-ROM or DVD in CD-ROM and/or DVD drive 716, on hard drive 714, or in memory 808 (FIG. 8) are executed by CPU 810 (FIG. 8). A portion of the program instructions, stored on these devices, can be suitable for carrying out all or at least part of the techniques described herein.

Although computer system 700 is illustrated as a desktop computer in FIG. 7, there can be examples where computer system 700 may take a different form factor while still having functional elements similar to those described for computer system 700. In some embodiments, computer system 700 may comprise a single computer, a single server, or a cluster or collection of computers or servers, or a cloud of computers or servers. Typically, a cluster or collection of servers can be used when the demand on computer system 700 exceeds the reasonable capability of a single server or computer. In certain embodiments, computer system 700 may comprise a portable computer, such as a laptop computer. In certain other embodiments, computer system 700 may comprise a mobile device, such as a smartphone. In certain additional embodiments, computer system 700 may comprise an embedded system.

Turning ahead in the drawings, FIG. 9 illustrates a block diagram of a device 900. Device 900 and the modules therein are merely exemplary and are not limited to the embodiments presented herein. Device 900 can be employed in many different embodiments or examples not specifically depicted or described herein. In some embodiments, certain elements or modules of device 900 can perform various procedures, processes, and/or acts. In other embodiments, the procedures, processes, and/or acts can be performed by other suitable elements or modules. In a number of embodiments, device 900 can be similar or identical to computer system 700 (FIG. 7), and can run one or more modules. In other embodiments, one or more of the modules can be run on one or more other devices, such as another one of computer system 700 (FIG. 7).

In some embodiments, device 900 can include an input module 901. In certain embodiments, input module 901 can receive input, and can at least partially perform block S102 (FIG. 5) of collecting EOS data, block S202 (FIG. 6) of collecting EOS data during the linear phase of the NDVI* growth curve for each Field m, and/or block S210 (FIG. 6) of acquiring EOS data for Field m to represent the spatial-yield pattern approximately on the DOY′.

In various embodiments, device 900 can include an output module 902. In certain embodiments, output module 902 can generate and/or display out, and can at least partially perform block S116 (FIG. 5) of displaying visual displays of the NDVI* across Field m, and/or block S118 (FIG. 5) of obtaining and displaying the yield measured at the time of harvest across Field m.

In a number of embodiments, device 900 can include a calculation module 903. In certain embodiments, calculation module 903 can at least partially perform block S104 (FIG. 5) of calculating reflectance and NDVI, block S106 (FIG. 5) of extracting NDVI scene statistics and calculating NDVI* based on these statistics for each pixel across the EOS image, block S110 (FIG. 5) of extracting NDVI* pixel data for a specific crop type λ on Field m, block S112 (FIG. 5) of extracting median values of NDVI* for Field m, block S114 (FIG. 5) of collecting field medians together to represent the growth of the crop through the season and determining the AED for each Field m, block S122 (FIG. 5) of determining an estimate of elapsed days, block S126 (FIG. 5) of estimating the elapsed days to DOY′ from AED according to the AED of Field m, block S204 (FIG. 6) of converting the linear growth phase data to NDVI*, block S206 (FIG. 6) of estimating AED for each Field m of crop type λ, block S208 (FIG. 6) of estimating when the spatial-yield pattern will naturally be displayed by Field m, block S212 (FIG. 6) of processing the spatial-yield pattern image for DOY′ to determine NDVI*, block S214 (FIG. 6) of extracting pixel values for NDVI* for Field m, and/or block S216 of optimizing the analysis for n classes of Field m.

In several embodiments, device 900 can include a mapping module 904. In certain embodiments, mapping module 904 can at least partially perform block S116 (FIG. 5) of displaying visual displays of the NDVI* across Field m, and/or block S118 (FIG. 5) of obtaining and displaying the yield measured at the time of harvest across Field m.

In some embodiments, device 900 can include a seed prescription module 905. In certain embodiments, seed prescription module 905 can at least partially perform block S220 (FIG. 6) of scaling the seeding density for the various zones in the field, and/or block S222 (FIG. 6) of transferring the variable seed density prescription through the API to the planter equipment.

Although the invention has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, a wide variety of crops and seeding densities other than those mentioned above may be employed depending upon the soil and crop in the field. Various delivery methods and mechanical systems may be employed for delivery of the prescribed amendments as determined by the variety of data from various sources as described above. As another example, to one of ordinary skill in the art, it will be readily apparent that any element of FIGS. 1-9 may be modified, and that the foregoing discussion of certain of these embodiments does not necessarily represent a complete description of all possible embodiments. For example, one or more of the procedures, processes, or activities of FIGS. 5-6 may include different procedures, processes, and/or activities and be performed by many different modules, in many different orders, and/or one or more of the procedures, processes, or activities of FIGS. 5-6 may include one or more of the procedures, processes, or activities of another different one of FIGS. 5-6.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method for prescribing variable seed density planting, the method comprising:
obtaining first EOS data collected approximately on an estimated day (DOY′) during a past crop-growing season in which NDVI* data most closely resembles a spatial-yield pattern measured during harvest in the past crop-growing season;
converting the first EOS data to first reflectance data and first NDVI data;
calculating first NDVI* data on a per pixel basis for the first EOS data based on the first NDVI data using satellite scene statistics of the first EOS data;
generating an NDVI* map for a first field using the first NDVI* data for the first EOS data; and
generating a variable seed density prescription map using the NDVI* map, the variable seed density prescription map being spatially defined.

2. The method of claim 1, further comprising:
determining when the DOY′ will occur for the first field growing a first crop type within a first farming region, comprising:
obtaining second EOS data collected through the past crop-growing season for the first farming region, the first farming region comprising an area having approximately a same climate and day length as the first field;
converting the second EOS data to second reflectance data and second NDVI data;
calculating second NDVI* data from the second NDVI data using satellite scene statistics of the second EOS data;
extracting the second NDVI* data for the first crop type on the first field;
determining an apparent emergence date (AED) for the first crop on the first field;
mapping the second NDVI* data across the first field for a latter at least one-third of the past crop-growing season on NDVI* maps;
displaying spatial yield data recorded spatially during harvest for the first field on a spatial yield data map for comparison with the NDVI* maps; and
receiving a selection for the DOY′ based on one of the NDVI* maps that best corresponds to the spatial yield data map.

3. The method of claim 2, wherein:
determining when the DOY′ will occur for the first field growing the first crop type within the first farming region further comprises:
calculating elapsed days from the AED to the DOY′ for the first crop type on the first field;
collecting a set of samples of elapsed day values based on AED values for a plurality of fields growing the first crop type within the first farming region, the plurality of fields comprising the first field;
graphing the set of samples of elapsed day values against the AED values for each of the plurality of fields; and
determining an estimated number of elapsed days from the AED to the DOY′ for a future field growing the first crop type within the first farming region.

4. The method of claim 3, wherein:
determining an estimated number of elapsed days from the AED to the DOY′ for a future field growing the first crop type within the first farming region comprises using linear regression.

5. The method of claim 2, wherein:
determining the apparent emergence date (AED) for the first crop on the field comprises:
graphing median values of the second NDVI* data for the first crop type on the first field by day of year (DOY);
selecting a first set of the median values of the second NDVI* data during a linear growth phase of the first crop type on the first field;
performing linear regression on the first set of the median values of the second NDVI* data in the linear growth phase of the first crop type on the first field; and
solving a linear equation resulting from the linear regression to yield the AED for the first crop type on the first field.

6. The method of claim 1, further comprising:
estimating when the DOY′ occurred for the first field growing a first crop type within a first farming region, comprising:
obtaining multiple sets of EOS data collected during a linear growth phase of the first crop type grown in the farming region an immediately prior crop-growing season, the first farming region comprising an area having approximately a same climate and day length as the first field;
converting the multiple sets of EOS data to second reflectance data, second NDVI data, and second NDVI* data;
determining an apparent emergence date (AED) for the first crop on the first field using linear regression on the second NDVI* data as expressed by day of year (DOY);
predicting the DOY′ using the AED for the first field;
selecting an archived image for a date that most closely corresponds to the DOY′, for the first field growing the first crop type within the first farming region;
extracting NDVI* pixel values from a portion of the multiple set of EOS data having a date that most closely corresponds to the calculated DOY′ for the first field with the first crop type; and
assembling a digital map of the NDVI* pixel values across the first field for the first crop type.

7. The method of claim 1, wherein:
generating a variable seed density prescription map using the NDVI* map further comprises:
obtaining a maximum recommended seeding density for the first crop type;
determining a variable seeding density based on the first NDVI* data across the NDVI* map for the first field, wherein the first NDVI* data is scaled based on (a) the maximum recommended seeding density for the first crop type being equivalent to an NDVI* value of 1.0 and (b) a minimum seeding density of zero being equivalent to an NDVI* value of zero, and wherein seeding densities for intermediate values are interpolated based on the scaling of the first NDVI* data and the NDVI* map; and
generating the variable seed density prescription map based on the variable seeding density as spatially defined across the first field.

8. The method of claim 1, wherein:
generating the variable seed density prescription map using the NDVI* map further comprises:
using a maximum seeding density for a first crop type on the first field based on an experience of a farmer of the first field;
setting the maximum seeding density for the first field and the first crop type equivalent to a maximum NDVI* value on the NDVI* map and a zero seeding density equivalent to a zero NDVI* value;
determining a variable seeding density by interpolating the first NDVI* data on the NDVI* map between the maximum seeding density and the zero seeding density; and
generating the variable seed density prescription map based on the variable seeding density as spatially defined across the first field.

9. The method of claim 1, further comprising:
planting spatially variable densities of seeds across the first field according to the variable seed density prescription map.

10. The method of claim 9, wherein:
planting spatially variable densities of the seeds across the first field according to the variable seed density prescription map further comprises:
identifying farm planting equipment that is equipped with a variable-seeding-density controller and a GPS location device; and
transferring the variable seed density prescription map to the farm planting equipment through an API of the farm planting equipment for the farm planting equipment to plant densities of the seeds across the first field according to position information provided by the GPS location device of the farm planning equipment and by seed density information provided by the variable seed density prescription map.

11. A system for prescribing variable seed density planting, the system comprising:
one or more processing modules; and
one or more non-transitory memory storage modules storing computing instructions configured to run on the one or more processing modules and perform the acts of:
obtaining first EOS data collected approximately on an estimated day (DOY′) during a past crop-growing season in which NDVI* data most closely resembles a spatial-yield pattern measured during harvest in the past crop-growing season;
converting the first EOS data to first reflectance data and first NDVI data;
calculating first NDVI* data on a per pixel basis for the first EOS data based on the first NDVI data using satellite scene statistics of the first EOS data;
generating an NDVI* map for a first field using the first NDVI* data for the first EOS data; and
generating a variable seed density prescription map using the NDVI* map, the variable seed density prescription map being spatially defined.

12. The system of claim 11, wherein the computing instructions are further configured to perform the acts of:
determining when the DOY′ will occur for the first field growing a first crop type within a first farming region, comprising:
obtaining second EOS data collected through the past crop-growing season for the first farming region, the first farming region comprising an area having approximately a same climate and day length as the first field;
converting the second EOS data to second reflectance data and second NDVI data;
calculating second NDVI* data from the second NDVI data using satellite scene statistics of the second EOS data;
extracting the second NDVI* data for the first crop type on the first field;
determining an apparent emergence date (AED) for the first crop on the first field;
mapping the second NDVI* data across the first field for a latter at least one-third of the past crop-growing season on NDVI* maps;
displaying spatial yield data recorded spatially during harvest for the first field on a spatial yield data map for comparison with the NDVI* maps; and
receiving a selection for the DOY′ based on one of the NDVI* maps that best corresponds to the spatial yield data map.

13. The system of claim 12, wherein:
determining when the DOY′ will occur for the first field growing the first crop type within the first farming region further comprises:
calculating elapsed days from the AED to the DOY′ for the first crop type on the first field;
collecting a set of samples of elapsed day values based on AED values for a plurality of fields growing the first crop type within the first farming region, the plurality of fields comprising the first field;
graphing the set of samples of elapsed day values against the AED values for each of the plurality of fields; and
determining an estimated number of elapsed days from the AED to the DOY′ for a future field growing the first crop type within the first farming region.

14. The system of claim 13, wherein:
determining an estimated number of elapsed days from the AED to the DOY′ for a future field growing the first crop type within the first farming region comprises using linear regression.

15. The system of claim 12, wherein:
determining the apparent emergence date (AED) for the first crop on the field comprises:
graphing median values of the second NDVI* data for the first crop type on the first field by day of year (DOY);
selecting a first set of the median values of the second NDVI* data during a linear growth phase of the first crop type on the first field;
performing linear regression on the first set of the median values of the second NDVI* data in the linear growth phase of the first crop type on the first field; and
solving a linear equation resulting from the linear regression to yield the AED for the first crop type on the first field.

16. The system of claim 11, wherein the computing instructions are further configured to perform the acts of:
estimating when the DOY′ occurred for the first field growing a first crop type within a first farming region, comprising:
obtaining multiple sets of EOS data collected during a linear growth phase of the first crop type grown in the farming region an immediately prior crop-growing season, the first farming region comprising an area having approximately a same climate and day length as the first field;
converting the multiple sets of EOS data to second reflectance data, second NDVI data, and second NDVI* data;
determining an apparent emergence date (AED) for the first crop on the first field using linear regression on the second NDVI* data as expressed by day of year (DOY);
predicting the DOY′ using the AED for the first field;
selecting an archived image for a date that most closely corresponds to the DOY′, for the first field growing the first crop type within the first farming region;
extracting NDVI* pixel values from a portion of the multiple set of EOS data having a date that most closely corresponds to the calculated DOY′ for the first field with the first crop type; and
assembling a digital map of the NDVI* pixel values across the first field for the first crop type.

17. The system of claim 11, wherein:
generating a variable seed density prescription map using the NDVI* map further comprises:
obtaining a maximum recommended seeding density for the first crop type;
determining a variable seeding density based on the first NDVI* data across the NDVI* map for the first field, wherein the first NDVI* data is scaled based on (a) the maximum recommended seeding density for the first crop type being equivalent to an NDVI* value of 1.0 and (b) a minimum seeding density of zero being equivalent to an NDVI* value of zero, and wherein seeding densities for intermediate values are interpolated based on the scaling of the first NDVI* data and the NDVI* map; and
generating the variable seed density prescription map based on the variable seeding density as spatially defined across the first field.

18. The system of claim 11, wherein:
generating the variable seed density prescription map using the NDVI* map further comprises:
using a maximum seeding density for a first crop type on the first field based on an experience of a farmer of the first field;
setting the maximum seeding density for the first field and the first crop type equivalent to a maximum NDVI* value on the NDVI* map and a zero seeding density equivalent to a zero NDVI* value;
determining a variable seeding density by interpolating the first NDVI* data on the NDVI* map between the maximum seeding density and the zero seeding density; and
generating the variable seed density prescription map based on the variable seeding density as spatially defined across the first field.

19. The system of claim 11, wherein the computing instructions are further configured to perform the acts of:
planting spatially variable densities of seeds across the first field according to the variable seed density prescription map.

20. The system of claim 19, wherein:
planting spatially variable densities of the seeds across the first field according to the variable seed density prescription map further comprises:
identifying farm planting equipment that is equipped with a variable-seeding-density controller and a GPS location device; and
transferring the variable seed density prescription map to the farm planting equipment through an API of the farm planting equipment for the farm planting equipment to plant densities of the seeds across the first field according to position information provided by the GPS location device of the farm planning equipment and by seed density information provided by the variable seed density prescription map.
